(19) United States
(12) Patent Application Publication
(10) Pub. No.: US 2023/0082119 A1
(43) Pub. Date: Mar. 16, 2023

(54) VIBRATING MASSAGER WITH INTERCHANGEABLE MASSAGING ATTACHMENTS

(71) Applicant: SpiraFlex Inc., Kansas City, MO (US)

(72) Inventor: Paul S. Francis, Overbrook, KS (US)

(73) Assignee: SpiraFlex Inc., Kansas City, MO (US)

(21) Appl. No.: 17/931,334

(22) Filed: Sep. 12, 2022

Related U.S. Application Data
(60) Provisional application No. 63/243,563, filed on Sep. 13, 2021.

(51) Int. Cl. A61H 11/00

(52) U.S. Cl. CPC A61H 11/00; A61H 2201/0153; A61H 2201/1669; A61H 2201/0107; A61H 2201/149; A61H 2201/1215; A61H 2201/5025

(57) ABSTRACT

A hand-held body massager includes a powered handle having an electric motor and reciprocating assembly mounted therein and a first mating coupler of a side-release buckle assembly connected to the reciprocating assembly to impart longitudinal, reciprocating movement of the first mating coupler relative to a powered handle. A plurality of massaging attachments incorporating a second mating coupler of the side-release buckle assembly are interchangeably securable to the powered handle. One of the massage attachments comprises a flexible strap with the second mating coupler connected to a first end and a second end, formed from a section of elastic material, connected to a passive handle. Other attachments include a plurality of massage head attachments each including a massage head of a different geometry and having a second mating coupler of a side-release buckle assembly projecting therefrom.

### CROSS-REFERENCE TO RELATED APPLICATIONS

This application claims the benefit to U.S. Provisional Patent Application No. Ser. No. 63/243,563, filed Sep. 13, 2021, the disclosure of which is incorporated by reference herein.

### BACKGROUND OF THE INVENTION

### Field of the Invention

This invention relates to hand-held, powered massaging devices.

### Description of the Related Art

In prior U.S. Pat. No. 5,097,822 of Francis et al, my co-inventors and I disclosed a hand-held reciprocating belt massager driven by an electric motor to massage sore muscles. The opposite ends of the belt are equipped with handles, one of which houses the motor and a drive train that reciprocates the belt longitudinally when the motor is in operation. The other hand grip connects flexibly with the belt through a resilient elastomer bar that accommodates the belt reciprocation. Hand-held percussion massagers with replaceable massaging heads of varying geometries for specific applications have become popular.

### SUMMARY OF THE INVENTION

A hand-held body massager includes a powered handle having an electric motor and reciprocating assembly mounted therein, and a first mating coupler of a side-release buckle assembly connected to the reciprocating assembly to impart longitudinal, reciprocating movement of the first mating coupler relative to a hand grip of the powered handle. A plurality of massaging attachments incorporating a second mating coupler of the side-release buckle assembly are interchangeably securable to the powered handle. One of the massage attachments comprises a flexible belt with the second mating coupler connected to a first end and the second end, formed from a section of elastic material, connected to a passive handle. Other attachments include a plurality of massage head attachments each including a massage head of a different geometry and having a second mating coupler of a side-release buckle assembly projecting therefrom.

### BRIEF DESCRIPTION OF THE DRAWINGS

FIG. 1 is a top, perspective view of a hand-held reciprocating belt massager with six interchangeable impact massage head attachments releasably securable to a powered handle of the massager.

FIG. 2 is a top, perspective view of the powered handle of the hand-held reciprocating massager as shown in FIG. 1 with the massage belt assembly and the top cover for the powered handle removed, an impact head attachment secured to the powered handle, and a portion of the female coupler cutaway to reveal the male coupler.

FIG. 3 is top, perspective view of the massage belt assembly, as shown in FIG. 1, removed from the powered handle and with belt attachments joined to the belt.

FIG. 4 is an exploded, perspective view of the bottom of the powered handle of the hand-held reciprocating massager as shown in FIG. 1, with the belt and a bottom cover of the powered handle removed.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

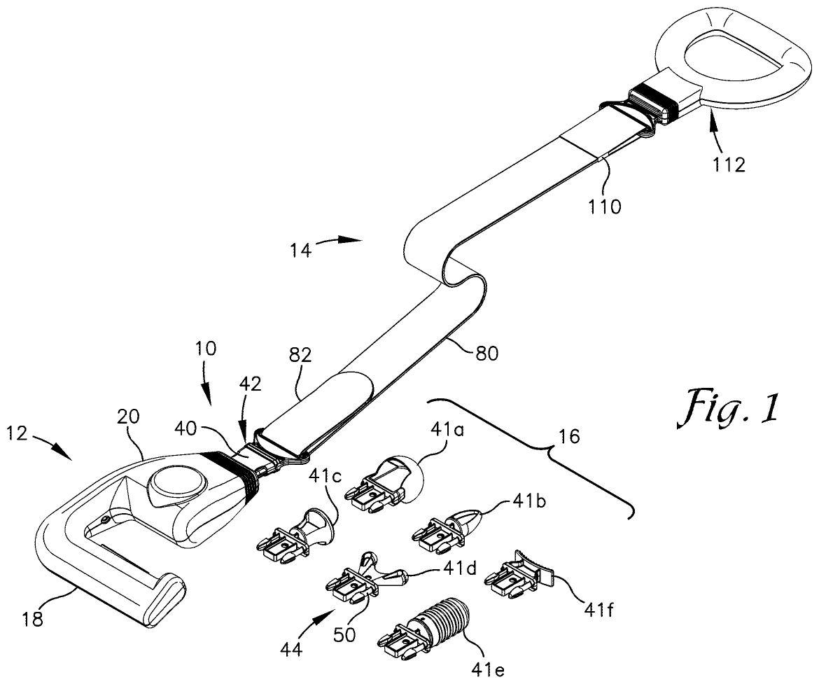

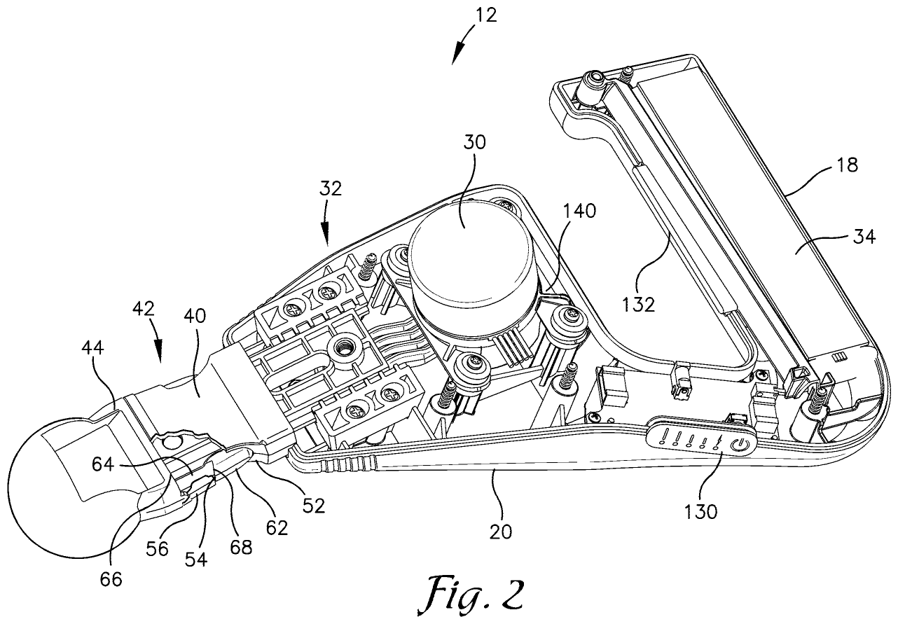

FIGS. 1 and 2 show a hand-held massager assembly 10 for massaging a body including a powered handle 12 in combination with a plurality of interchangeable massage attachments including a massage belt assembly or attachment 14 and a plurality of massage head attachments 16. The powered handle 12 includes a hand grip 18 connected to a base portion or a handle body 20 with an electric motor 30 coupled to a reciprocating assembly 32 mounted or positioned within a hollow interior portion of the handle body 20. One or more rechargeable batteries 34 are also mounted within an interior of the powered handle 12 to supply electrical power to the motor 30 which upon energization drives the reciprocating assembly 32. The motor 30, reciprocating assembly 32, batteries 34 and their electrical connection may be configured in a manner similar to that shown in U.S. Pat. No. 5,097,822 of Francis et al, the disclosure of which is incorporated herein by reference.

A first mating portion or a first mating coupler 40 of a side-release buckle assembly 42 is reciprocally mounted on the powered handle 12 and operably connected to or coupled with the reciprocating assembly 32 which imparts longitudinal, reciprocating movement of the first mating coupler 40 of buckle assembly 42 relative to the powered handle 12. The massage belt assembly 14 and each of the massage head attachments 16 each have a second mating portion or second mating coupler 44 of the buckle assembly 42 connected thereto. In the embodiment shown, the first mating coupler 40 comprises a receiver, socket or female coupler and the second mating coupler 44 comprises a male coupler with resilient prongs 50 which are compressed when inserted into the receiver and then expand into openings 52 in the side of the receiver to secure the male coupler 44 to the female coupler 40. To disconnect the male coupler 44 from the female coupler 40, the portions of the prongs 50 extending through the openings 52 in the sides of the female coupler 40 are compressed inward and the male coupler 44 is pulled away from the female coupler 40.

The buckle assembly 42 may be a side release buckle assembly of the type shown in U.S. Pat. No. 5,465,472. It is foreseen that other types of buckles or connectors could be used to connect the attachments to the powered handle 12. It is also foreseen that the male coupler 44 of the buckle assembly 42 could be secured in the end of the powered handle 12 and connected to the reciprocating assembly 32 and the female coupler 40 could be connected to the attachment.

In the embodiment of the buckle assembly 42 shown, the openings 52 formed through sides of the female coupler 40 are surrounded by or defined by a barb engaging portion 54 of a sidewall 56 of the female coupler 40 at a distal end of the opening 52. Each barb engaging portion 54 of the female coupler sidewall 56 may be described as facing rearward or toward the hand grip 18 of the powered handle 12.

Each prong 50 includes a barb 62 formed on an end of a stem 64 connected to and projecting outward from a base 66 of each massage head attachment 16 opposite a respective head 41a, 41b, 41c, 41d, 41e, and 41f. Each barb 62 slopes outwardly and toward the massage head attachment base 66 and forms an abutment surface 68 projecting outward relative to the stem 64. In a preferred embodiment, the abutment surface 68 slopes slightly toward the massage head attachment base 66 as it extends outward from the stem 64 to which it is attached. When the prongs 50 of a selected massage head attachment 16 are inserted into the female coupler 40, the prongs 50 initially compress as the outer surface of each barb 62 advances past a distal end of a respective female coupler sidewall 56. As the abutment surface 68 of each prong 50 is subsequently advanced just past the barb engaging portion 54 of the respective female coupler sidewall 56, the barbs 62 expand outward so that the abutment surface 68 of each barb 62 extends in overlapping relationship with a respective barb engaging portion 54 of the associated female coupler sidewall 56 to resist or prevent withdrawal of the prongs 50 of the male coupler 44 from the female coupler or socket 40 without first compressing the barbs 62 inward. Compressing the barbs 62 inward advances the abutment surface 68 of each barb 62 inward past the adjacent barb engaging portion 54 of the respective female coupler sidewall 56 to allow withdrawal of the prongs 50 from the female coupler or socket 40.

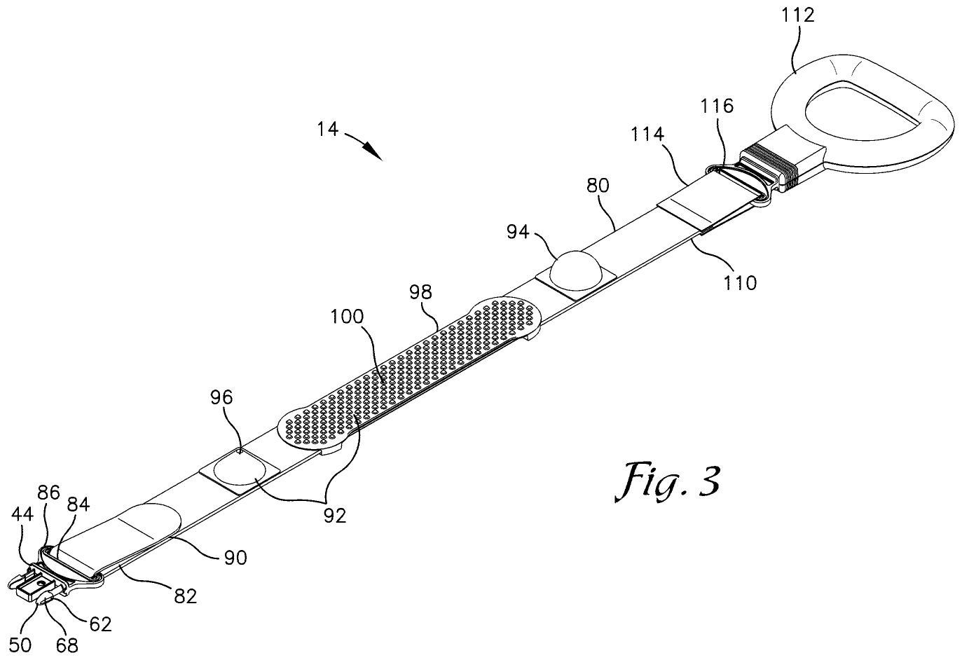

In the embodiment shown in FIG. 3, the massage belt assembly 14 includes a reciprocating, elongate, flexible strap or belt 80 having the second mating coupler 44 connected to a first end 82 of the belt 80. The first end 82 of the belt 80 is looped through a slot 84 formed in a tab 86 integrally formed with the second mating coupler 44 of the buckle assembly 42 and adjustably secured back onto itself with a hook and loop type fastening system 90. The second mating coupler 44 is preferably constructed similar to the mating coupler 44 of each massage head attachment 16. In a preferred embodiment, a hook or loop material of a hook and loop fastening system extends along the length of the belt 80 or along portions of the belt 80, and belt attachments 92 with the opposing hook or loop material than the hook or loop material included on the belt 80 can be optionally joined to the belt 80. The belt attachments 92 may include hard massage tips formed into shapes that can range from rounded tips 94 to pointed tips 96, elastomer pads 98 that are textured with massage nibs 100, and other attachments that may be contemplated by a person of ordinary skill in the art. A second end 110 of the belt 80 is connected to a passive handle 112. In the embodiment shown, a section 114 of the second end 110 of the belt 80 is formed from a length or section of elastic material or fabric which is looped through a slotted connector 116 on the end of the passive handle 112 and secured back onto itself and onto the belt 80. When the first end 82 of the belt 80 is connected to the powered handle 12 by the buckle assembly 42, reciprocal movement of the first mating coupler 40 by the motor 30 and the reciprocating assembly 32 imparts lateral massage or longitudinal reciprocal movement of the belt 80 relative to the powered handle 12 and the passive handle 112. The section 114 of elastic fabric at the second end 110 of belt 80 draws the second end 110 of the belt 80 back toward the passive handle 112 after advancement of the belt 80 away from the passive handle 112 due to the action of the motor 30 and reciprocating assembly 32 on belt 80. The mating engagement and interaction of the abutment surface 68 of each barb 62 on prongs 50 against the respective barb engaging portion 54 of the associated female coupler sidewall 56 in the female coupler 40 prevents male coupler 44 connected to the belt 80 from being pulled out of the female coupler 40 during use of the belt 80 and without first manually compressing the barbs 62.

The interchangeable massage head attachments 16 each include a head 41a, 41b, 41c, 41d, 41e, and 41f of a different geometry with one of the second mating couplers 44 of the buckle assembly 42 fixed to and projecting away from the respective head 41a-41f. Each massage head attachment 16 is releasably securable to the first mating coupler 40 on the powered handle 12 by their respective second mating coupler 44 of the buckle assembly 42. Reciprocation of the first mating coupler 40 by the motor 30 and reciprocating assembly 32 in powered handle 12 causes percussive massage or longitudinal reciprocal motion of the massage head attachment 16 secured thereto. The heads 41a-41f of massage head attachments 16 include different geometries to enable directing of impacts from the head 41a-41f to different portions of a user's body and to vary the application of the impacts and the massaging effect. When the second mating coupler 44 of the buckle assembly 42 and attached belt 80 are removed from the first mating coupler 40 on powered handle 12, the selected massage head attachments 16 with the second mating coupler 44 of the buckle assembly 42 may be interchangeably inserted within the first mating coupler 40 of the buckle assembly 42 reciprocally mounted on the powered handle 12. An embodiment of the massaging assembly or apparatus 10 preferably includes at least one of the massage head attachments 16 and at least one massage belt assembly 14. In addition to multiple massage head attachments 16 of different geometries, it is foreseen that the apparatus could include multiple belt assemblies 14 with belts 80 of different materials or widths or other variations to vary the massaging action.

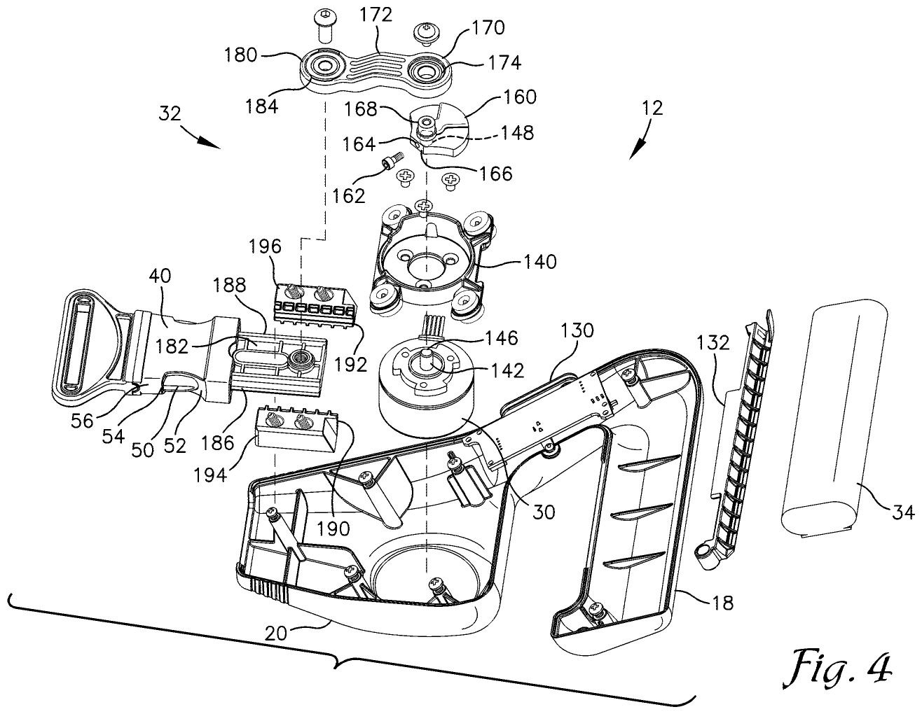

In the embodiments shown in FIGS. 2 and 4, a switch or button 130 for energizing and de-energizing the motor 30 and for controlling the speed of the motor 30 may be incorporated into the powered handle 12 preferably on a side thereof. A compression switch 132 is incorporated into the hand grip 18 and compressible to close the switch 132 to cause the motor 30 to engage the reciprocating assembly 32. A power socket (not shown) is formed in the powered handle 12 for receiving a charging plug (not shown) to recharge batteries 34 providing power to the motor 30.

The massage belt assembly 14 and massage head attachments 16 are longitudinally reciprocated by the reciprocating assembly 32 and the electric motor 30 which are mounted within the hollow portion of the handle body 20 forming part of the powered handle 12. The electric motor 30 is preferably a multi-speed electric motor which has multiple speeds of operation. In the present embodiment the electric motor 30 is a four-speed electric motor which is mounted on a motor mount 140 and the motor mount 140 is mounted to projections extending internally on the interior surface of the handle body 20. When energized, the motor effects rotational motion of a an output shaft or drive shaft 142 extending from the electric motor 30 and the drive shaft 142 engages the reciprocating assembly 32, which in the embodiment shown comprises a slider-crank mechanism, to convert rotary motion of the drive shaft 142 into linear motion and effect the longitudinal reciprocating motion of the massage belt assembly 14 or massage head attachments 16.

In the embodiment shown, the drive shaft 142 includes a flattened side 146 to form a D-shaped cross-section adapted to mate with a D-shaped through-hole 148 formed on a crank base 160. The crank base 160 is secured to the drive shaft 142 by a set screw 162 extending laterally through a threaded set screw hole 164 in a notched section 166 on the side of the crank base 160 and intersecting with the flat surface 146 of the drive shaft 142 securing, through pressure and friction, the drive shaft 142 to the crank base 160.

As best shown in FIG. 4, an offset crank pin or post 168 is formed on and offset from a center of the crank base 160. A proximal end 170 of a crank arm or crank shaft 172 is rotatably mounted to the crank pin 168 through a proximal end bearing assembly 174. The proximal end 170 of the crank arm 172 is mounted eccentrically or off-center of the center of the drive shaft 142 causing the proximal end 170 of the crank arm 172 to rotate in an orbital fashion around the drive shaft 142 when the electric motor 30 is energized.

The distal end 180 of the crank arm 172 is rotatably connected to a slider 182 through a distal end bearing assembly 184. The crank arm 172 is shown formed with a bend to facilitate connection of the distal end 180 of the crank arm 172 to the slider 182. The slider 182 is formed on an inner end of the first mating coupler 40 of the side-release buckle assembly 42. Longitudinally oriented flanges 186 and 188 project laterally outward from sides of the slider 182 and are received in longitudinally oriented slots 190 and 192 formed in slider guiding members or brackets 194 and 196 mounted within the handle body 20. The guiding brackets 194, 196 and slots 190, 192 limit the movement of the slider 182 to a longitudinal, reciprocating movement. The reciprocating assembly 32 imparts substantially longitudinal, reciprocating movement to the first mating coupler 40 of the side-release buckle assembly 42 relative to the powered handle 12.

It is to be understood that while certain forms of the present invention have been illustrated and described herein, it is not to be limited to the specific forms or arrangement of parts described and shown.

What is claimed is:

1. An apparatus for massaging a body, comprising:
a powered handle and a passive handle;
the powered handle having a hand grip connected to a handle body and a motor positioned within a hollow interior of the handle body, a reciprocating assembly positioned within the hollow interior of the handle body and coupled between the motor and a first mating coupler of a side release buckle assembly operable to effect longitudinal, reciprocating movement of the first mating coupler relative to the handle body when the motor is energized;
an elongate, flexible strap having a first of a second mating coupler of the side release buckle assembly connected to a first end of the elongate, flexible strap and a second end of the elongate, flexible strap includes a section of elastic material and the second end is connected to the passive handle; and
at least one massage head attachment comprising a massage head and a second of the second mating coupler of the side release buckle assembly connected thereto; wherein,
the first end of the elongate, flexible strap and the at least one massage head attachment are interchangeably securable by their respective first and second, second mating coupler to the first mating coupler of the side release buckle assembly reciprocally mounted to the powered handle.

2. The apparatus for massaging a body in claim 1, wherein the reciprocating assembly comprises a slider-crank mechanism.

3. The apparatus for massaging a body in claim 1, further comprising a switch in the powered handle for engaging a battery to energize the motor, wherein engaging the switch closes the switch, engaging the battery and energizing the motor.

4. The apparatus for massaging a body in claim 3, wherein the switch is a compressible switch in the hand grip.

5. The apparatus for massaging a body in claim 1, further comprising a power switch for energizing the motor, wherein the motor has multiple speeds of operation, and the power switch operates to set the speed of the motor.

6. The apparatus for massaging a body in claim 1, further comprising the motor having a shaft, wherein energizing the motor effects rotational motion of the shaft and the rotational motion of the shaft effects longitudinal reciprocating movement of the first mating coupler.

7. The apparatus for massaging a body in claim 6, wherein a slider is formed on the first mating coupler and a crank arm is connected between the slider and an offset crank pin on a crank base connected to the shaft of the motor for effecting substantially longitudinal reciprocating movement of the first mating coupler.

8. The apparatus for massaging a body as in claim 1, wherein the first mating coupler comprises a socket with openings formed in sidewalls of the socket and the first and second, second mating couplers each include prongs having barbs formed thereon with outwardly projecting abutment surfaces formed on an outwardly facing end of each barb and adapted to abut against and engage portions of a socket sidewall adjacent the openings to prevent withdrawal of the first and second, second mating couplers from the first mating coupler.

9. The apparatus for massaging a body as in claim 1, further comprising belt attachments releasably securable to the elongate, flexible strap.

10. An apparatus for massaging a body, comprising:
a powered handle comprising a handle body, a hand grip, and a first mating coupler of a side release buckle assembly;
a passive handle; and
an elongate, flexible strap having a first end and a second end, the first end of the strap is adjustably secured to a first of a second mating coupler of the side release buckle assembly, the second end of the strap has an elastic portion, and the second end is connected to the passive handle, wherein
the powered handle has a motor positioned within a hollow interior of the powered handle, the motor is coupled to a reciprocating assembly, and the reciprocating assembly is coupled to the first mating coupler of the side release buckle assembly, wherein energizing the motor effects longitudinal, reciprocating movement of the first mating coupler relative to the powered handle;
the first mating coupler of the side release buckle assembly of the powered handle is removably securable to the first, second mating coupler of the side release buckle assembly of the strap, and
the first, second mating coupler of the strap is comprised of at least one prong with an abutment surface sloping outwardly and the at least one prong is compressible while advancing the first, second mating coupler within the first mating coupler, wherein the abutment surface of the at least one prong engages the first mating coupler to removably secure the first, second mating coupler to the first mating coupler.

11. The apparatus for massaging a body of claim 10, further comprising at least one massage head attachment having a massage head fixed to a second of the second mating coupler of the side release buckle assembly, wherein the second, second mating coupler of the at least one massage head attachment is removably securable to the first mating coupler of the side release buckle assembly reciprocally mounted to the powered handle, and wherein the strap having the first, second mating coupler of the side release buckle assembly and the at least one massage head attachment having the second, second mating coupler of the side release buckle assembly are interchangeably securable to the first mating coupler of the side release buckle assembly of the powered handle.

12. The apparatus for massaging a body of claim 10, wherein the reciprocating assembly is comprised of a slider-crank mechanism and a slider of the slider-crank mechanism is positioned within the handle body and is formed on the first mating coupler.

13. The apparatus for massaging a body in claim 12, wherein a crank arm connects the slider to an offset crank pin on a crank base connected to an output shaft of the motor.

14. The apparatus for massaging a body of claim 10, further comprising a compressible switch on the hand grip for energizing the motor, wherein the compressible switch is compressed to energize the motor.

15. The apparatus for massaging a body in claim 10, further comprising a power switch for energizing the motor, wherein the motor has multiple speeds of operation, and the power switch operates to set the speed of the motor.

16. The apparatus for massaging a body of claim 10, further comprising belt attachments releasably securable to the elongate, flexible strap.

17. The apparatus for massaging a body of claim 10, wherein the first, second mating coupler is removable secured to the first mating coupler and compressing the at least one prong of the first, second mating coupler inward advances the abutment surface of the at least one prong inward relative to an adjacent sidewall of an opening in the first mating coupler to allow withdrawal of the first, second mating coupler from the first mating coupler.

18. An apparatus for massaging a body, comprising:
a powered handle having a hand grip connected to a handle body, a motor with an output shaft positioned within a hollow interior of the handle body, a compressible switch for energizing the motor positioned on the hand grip, and a reciprocating assembly positioned within the hollow interior of the handle body, wherein the reciprocating assembly is coupled between the output shaft and a first mating coupler of a side release buckle assembly operable to effect longitudinal, reciprocating movement of the first mating coupler relative to the handle body when the motor is energized;
a passive handle;
an elongate, flexible strap having a first end and a second end, the first end of the elongate, flexible strap adjustably securable to a first of a second mating coupler of the side release buckle assembly, and the second end of the elongate, flexible strap having an elastic section, wherein the second end is connected to the passive handle; and
at least one massage head attachment comprising a massage head and a second of a second mating coupler of the side release buckle assembly connected thereto; wherein,
the first, second mating coupler of the elongate, flexible strap and the second, second mating coupler of the at least one massage head attachment are interchangeably securable by their respective second mating coupler to the first mating coupler of the side release buckle assembly reciprocally mounted to the powered handle; and
the first, second mating coupler of the elongate, flexible strap and the second, second mating coupler of the at least one massage head attachment each have at least one prong with a barb, the barb having an abutment surface, and the abutment surface interacting with a barb engaging portion on the first mating coupler to interchangeably secure each second mating coupler to the first mating coupler.

19. The apparatus for massaging a body of claim 18, further comprising a power switch for energizing the motor, wherein the motor has multiple speeds of operation, and the power switch operates to set the speed of the motor.

20. The apparatus for massaging a body of claim 18, wherein the reciprocating assembly is comprised of a slider-crank mechanism connected between the first mating coupler and the output shaft, wherein a slider of the slider-crank mechanism is formed on the first mating coupler of the side release buckle assembly, and a crank arm connects the slider to a crank pin that orbits the output shaft.

21. The apparatus for massaging a body of claim 18, further comprising belt attachments removably securable to the elongate, flexible strap.
